(19) United States
(12) Patent Application Publication
(10) Pub. No.: US 2018/0208433 A1
(43) Pub. Date: Jul. 26, 2018

(54) SAFETY BLOCK FOR ELEVATOR

(71) Applicant: Otis Elevator Company, Farmington, CT (US)

(72) Inventor: Aurelien Fauconnet, Isdes (FR)

(21) Appl. No.: 15/745,756

(22) PCT Filed: Jul. 29, 2015
(86) PCT No.: PCT/IB2015/001483

§ 371 Date: Jan. 18, 2018

(51) Int. Cl. B66B 5/20

(52) U.S. Cl. CPC B66B 5/20

(57) ABSTRACT

An elevator safety block including a frame configured to attach to an elevator structure, e.g., an elevator car or counterweight, and slidably engage with a guide rail, the frame defining a first engaging surface and a support surface, an intermediate body slidably mounted to the support surface, and an engaging body rotatably attached to the intermediate body and having a second engaging surface. In a first position, the first engaging surface and the second engaging surface are configured to permit the elevator structure to move along the guide rail, and, in a second position, the first engaging surface and the second engaging surface are configured to engage with the guide rail and prevent movement of the elevator structure.

### BACKGROUND

Embodiments are directed to emergency safety features of elevators and more particularly to safety blocks for elevator cars or counterweights.

Elevators typically include a safety system to stop an elevator car or counterweight from traveling at excessive speeds in response to an elevator component breaking or otherwise becoming inoperative, or deviations from an intended motion profile due to motion control software errors. Traditionally, elevator car safety systems include a mechanical speed sensing device commonly referred to as an overspeed governor, a governor rope, and a mechanical linkage connected to an elevator safety block for selectively frictionally engaging elevator guiderails to thus halt or stop an elevator car or counterweight. The overspeed governor is traditionally mounted either in a machine room or in the top or bottom of the hoistway. The safety system is mounted on the car, and a linkage or governor rope hitch connects the system with the governor. When the governor detects a dangerous situation due to excessive travelling speed, it sends a force to the elevator safety block through the tensioned governor rope and linkage. The elevator safety block then engages the guiderails and stops the elevator car or counterweight.

The elevator safety block provides an ultimate stop mechanism in the event of an emergency, such as excessive speed or suspension rope breakage. Traditional elevator safety blocks may be configured with a wedge principle of operation. In the case of safety actuation, as described above, a wedge or roller is configured to move upward within a frame of the elevator safety block and catch and frictionally engage with a guide rail to thus stop an elevator car or counterweight. Once engaged, after an emergency is resolved, the elevator safety block must be disengaged to enable the elevator car or counterweight to operate properly. To disengage the wedges or rollers of the elevator safety block, an upward force must be applied to release the pressures and forces on the wedges or rollers, and thus release them from engagement with the guide rail. In some configurations a rail grabber tool may be used to provide sufficient force to disengage the wedges or rollers. In other configurations, the drive motor of the elevator car may be operated in an over-drive mode to provide sufficient force to overcome the engaged wedges or rollers of the elevator safety block.

### BRIEF DESCRIPTION

According to one embodiment an elevator safety block is provided. The elevator safety block includes a frame configured to attach to an elevator car or counterweight and slidably engage with a guide rail, the frame defining a first engaging surface and a support surface. An intermediate body is slidably mounted to the support surface. An engaging body is rotatably attached to the intermediate body and having a second engaging surface. In a first position, the first engaging surface and the second engaging surface are configured to permit the elevator car or counterweight to move along the guide rail and, in a second position, the first engaging surface and the second engaging surface are configured to engage with the guide rail and prevent movement of the elevator car or counterweight.

In addition to one or more of the features described above, or as an alternative, further embodiments may include that the frame includes at least one support aperture passing through the support surface, the intermediate body comprising at least one pin configured to slidably move within the at least one support aperture.

In addition to one or more of the features described above, or as an alternative, further embodiments may include at least one biasing device located on the at least one pin and positioned between the intermediate body and the support surface.

In addition to one or more of the features described above, or as an alternative, further embodiments may include at least one pivot configured to rotatably attach the engaging body to the intermediate body.

In addition to one or more of the features described above, or as an alternative, further embodiments may include that the at least one pivot is two pivots, and wherein the engaging body, the intermediate body, and the two pivots define a deformable parallelogram.

In addition to one or more of the features described above, or as an alternative, further embodiments may include that the engaging body is configured to move to the second position when the elevator car or counterweight is in an emergency situation.

In addition to one or more of the features described above, or as an alternative, further embodiments may include that the engaging body is positioned parallel to the guide rail in both the first position and the second position.

In addition to one or more of the features described above, or as an alternative, further embodiments may include a cover configured to protect the intermediate body and the engaging body within the frame.

According to another embodiment a method of operating an elevator safety block is provided. The method includes detecting an emergency situation of an elevator car or counterweight, operating an emergency elevator safety block on the elevator car or counterweight to move from a first position to a second position, and engaging the second position such that a guide rail is engaged between a first engaging surface of a frame of the emergency elevator safety block and a second engaging surface of an engaging body of the emergency elevator safety block to thereby prevent the elevator car or counterweight from moving relative to the guide rail. In the first position, the emergency elevator safety block is configured to permit the elevator car or counterweight to move freely with respect to the guide rail.

In addition to one or more of the features described above, or as an alternative, further embodiments may include that the elevator safety block comprises a first engaging surface on a frame and a second engaging surface on an engaging body, the method further comprising maintaining the first engaging surface and the second engaging surface in parallel relationship in both the first position and the second position.

In addition to one or more of the features described above, or as an alternative, further embodiments may include that engaging the second position comprises rotatably moving the engaging body with respect to the frame.

In addition to one or more of the features described above, or as an alternative, further embodiments may include that the elevator safety block further comprises an intermediate body configured between the engaging body and a support surface of the frame.

In addition to one or more of the features described above, or as an alternative, further embodiments may include that engaging the second position comprises translating the intermediate body with respect to the frame.

In addition to one or more of the features described above, or as an alternative, further embodiments may include disengaging the elevator safety block from the second position to enable movement of the elevator car or counterweight.

In addition to one or more of the features described above, or as an alternative, further embodiments may include that the disengaging comprises moving the elevator car or counterweight upward within an elevator shaft.

Technical effects of embodiments of the present disclosure include providing an elevator safety block for an elevator car or counterweight that can stop an elevator car or counterweight in the event of an emergency but is also easily released from engagement after stopping an elevator car or counterweight. Further technical effects include a deformable parallelogram configuration for an elevator safety block, such that minimal upward force may be required to disengage an engaged elevator safety block.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the disclosure;

FIG. 2A is a schematic illustration of an emergency braking system of an elevator system;

FIG. 2B is an enlarged schematic illustration of an emergency braking system of an elevator system;

FIG. 3A is a is a schematic illustration of an elevator safety block in accordance with an embodiment of the present disclosure;

FIG. 3B is an alternative view of the elevator safety block shown in FIG. 3A;

FIG. 3C is an exploded view of the elevator safety block of FIG. 3A;

FIG. 4A is a side view of an elevator safety block in accordance with an embodiment of the present disclosure, shown in a first position;

FIG. 4B is a side view of the elevator safety block of FIG. 4A in an intermediate position;

FIG. 4C is a side view of the elevator safety block of FIG. 4A in a second position;

FIG. 5A is an illustrative view of an elevator safety block in accordance with an embodiment of the present disclosure;

FIG. 5B is an alternative illustrative view of the elevator safety block of FIG. 5A; and

FIG. 6 is a process for operating an elevator in accordance with an embodiment of the present disclosure.

### DETAILED DESCRIPTION

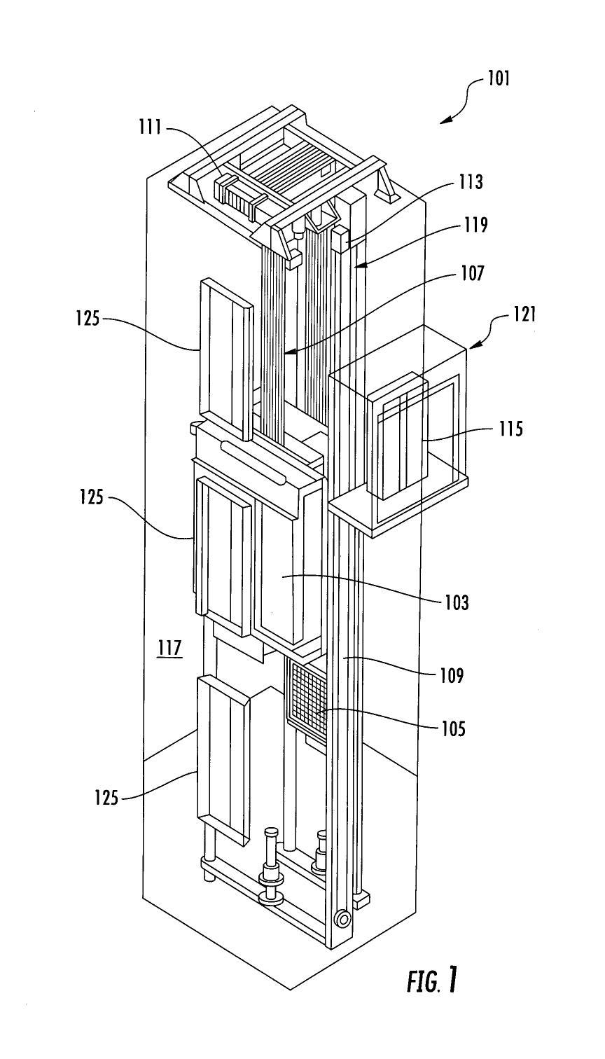

FIG. 1 is a perspective view of an elevator system 101 including an elevator car 103, a counterweight 105, a roping 107, a guide rail 109, a machine 111, a position encoder 113, and a controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position encoder 113. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor.

Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

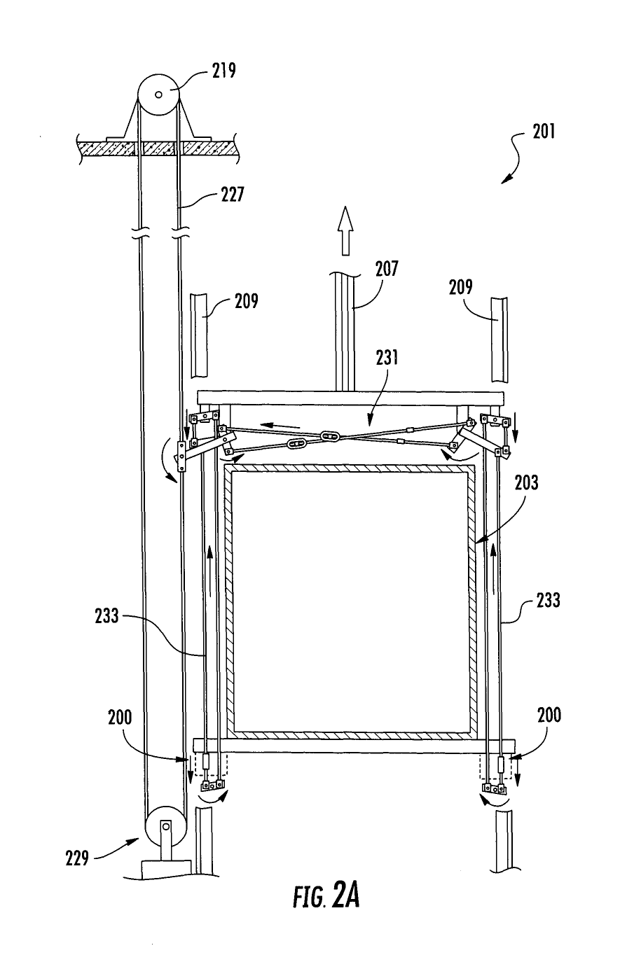

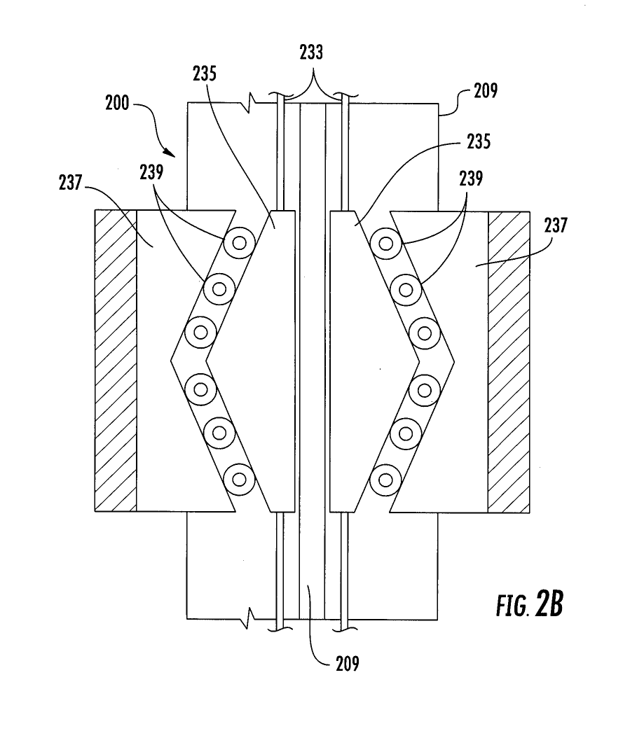

Referring to FIGS. 2A and 2B, an example of a traditional elevator safety block 200, configured as a brake, will now be described. FIG. 2A shows an elevator system 201 employing the elevator safety block 200 and FIG. 2B shows as detailed view of the elevator safety block 200. The elevator system 201 includes an elevator car 203, guide rails 209 for guiding the elevator car 203 in upward and downward motion within an elevator shaft along guide rails 209, and roping 207 for raising and lowering the elevator car 203.

The safety mechanism for the elevator car 203 includes a governor 219, an endless governor rope 227, a tension adjuster 229 for the governor rope 227, elevator safety blocks 200 mounted on the elevator car 203 for stopping the elevator car 203 in the event of overspeeding, and a mechanical linkage 231 mounted on the elevator car 203 and connecting the governor rope 227 to the elevator safety blocks 200. The elevator safety blocks 200 are configured to releasably engage with the guide rails 209 to apply a braking force to the elevator car 203 in the event of an overspeed situation.

In operation, as the elevator car 203 starts to overspeed downwardly, the governor rope 227 and governor 219 start to overspeed, thereby tripping the governor 219 which prevents further overspeeding of the governor rope 227. The governor rope 227 moves more slowly than the elevator car 203 thereby tripping the linkage 231. When the linkage 231 is tripped, the configuration pulls upward on actuators 233 which activate the elevator safety blocks 200. When the elevator safety blocks 200 are activated, the elevator safety blocks 200 will engage with the guide rails 209 and stop the elevator car 203.

Referring now to FIG. 2B, a detailed schematic of the elevator safety block 200 is shown. The elevator safety block 200 of FIG. 2 includes two parts, wedges 235 and wedge guides 237 that are configured about the guide rail 209. The wedge guides 237 are mounted in a fixed position relative to the elevator car 203. The wedges 235 are mounted so as to be movable vertically upwardly or downwardly relative to the elevator car 203 and are connected to the linkage 231 by the actuators 233.

During normal operation of the elevator car 203, that is to say when the elevator car 203 is travelling upwardly or downwardly at normal speed, the wedges 235 and wedge guides 237 are not in contact with the guide rail 209. However, if the elevator car 203 overspeeds downwardly thereby operating the linkage 231, the actuators 233 are caused to move upward. The upward motion of the actuators 233 forces the wedges 235 vertically upwardly relative to the wedge guides 237. A set of rollers 239 are provided between the wedge guides 237 and the wedges 235 to permit the relative movement. As the wedges 235 move up relative to the wedge guides 237, the wedges 235 also move horizontally toward the guide rail 209 as a result of the shape of the wedges 235 and wedge guides 237, and engage the elevator car guide rail 209, so as to prevent further movement of the elevator car 203.

Although shown and described with respect to a specific configuration in FIGS. 2A and 2B, those of skill in the art will appreciate that other configurations and/or components and/or features may be possible. Thus, the configuration of FIGS. 2A and 2B are merely provided for illustrative and explanatory purposes. It will be appreciated by those of skill in the art that traditional elevator safety blocks, such as shown in FIG. 2B, incorporate two movable portions positioned on either side of the guide rail.

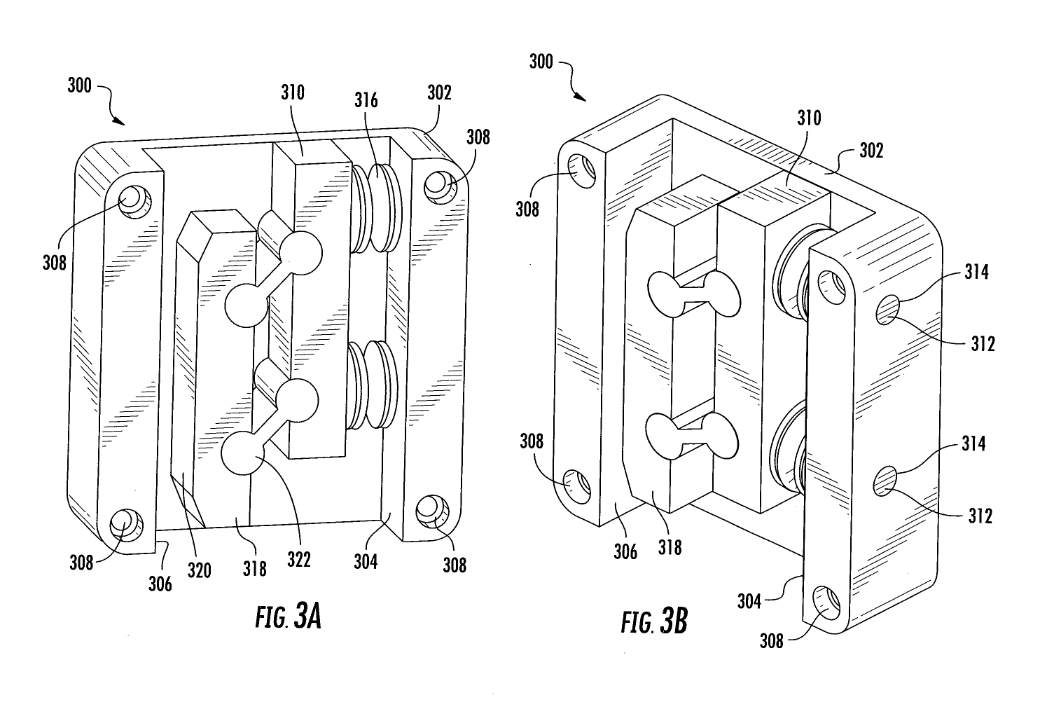

Turning now to FIGS. 3A-3C, views of an elevator safety block 300 in accordance with an embodiment of the present disclosure are shown. FIG. 3A shows a first isometric view of an elevator safety block 300. FIG. 3B shows an alternative isometric view of the elevator safety block 300. FIG. 3C shows an exploded view of the components of the elevator safety block 300.

As shown in FIGS. 3A-3C, the elevator safety block 300 includes a frame 302 that supports components of the elevator safety block 300. The elevator safety block 300 is configured to interact with a guide rail of an elevator shaft to provide emergency braking or stopping power. The frame 302 is configured to be mounted onto an elevator structure, such as an elevator car or counterweight (not shown), and is configured to allow for operable engagement of the elevator safety block 300 with a guide rail (not shown) of an elevator system. The frame 302 includes a support surface 304 and a first engaging surface 306 that is opposite the support surface 304. The frame 302 may also include one or more mounting apertures 308 configured to enable mounting of the frame 302 to an elevator structure.

Moveably engaged with the support surface 304 is an intermediate body 310. The intermediate body 310 may include one or more pins 312 that slidably engage with one or more respective support apertures 314 that pass through the support surface 304. As shown, the mounting apertures 308 and the support apertures 314 are oriented perpendicular to each other. The pins 312 are configured to maintain the intermediate body 310 in slidable engagement with the frame 302 and are also configured to support one or more biasing devices 316. The biasing devices 316 may be springs, such as spring washers, leaf springs, or other types of biasing devices and mechanisms. In some embodiments, the biasing devices 316 are configured to bias the intermediate body 310 away from the support surface 304 when the biasing devices 316 are compressed. That is, the biasing devices 316 urge the intermediate body 310 away from the support surface 304 and toward the first engaging surface 306 when the intermediate body 310 is moved toward the support surface 304 and the biasing devices 316 are compressed between the intermediate body 310 and the support surface 304. Further, in some embodiments, the biasing devices 316 may be configured to absorb shock during a braking operation.

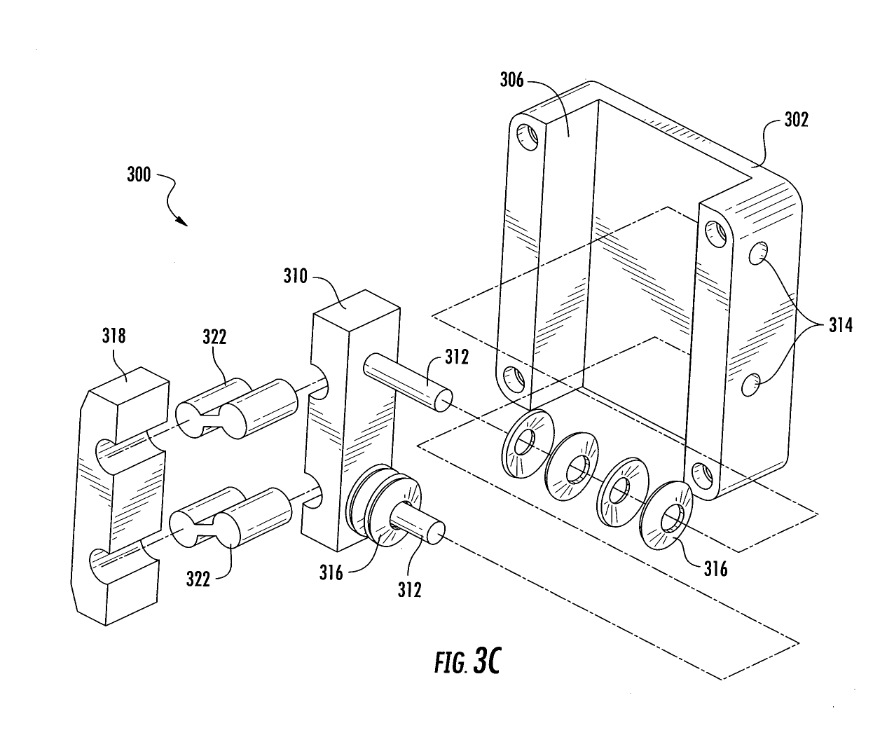

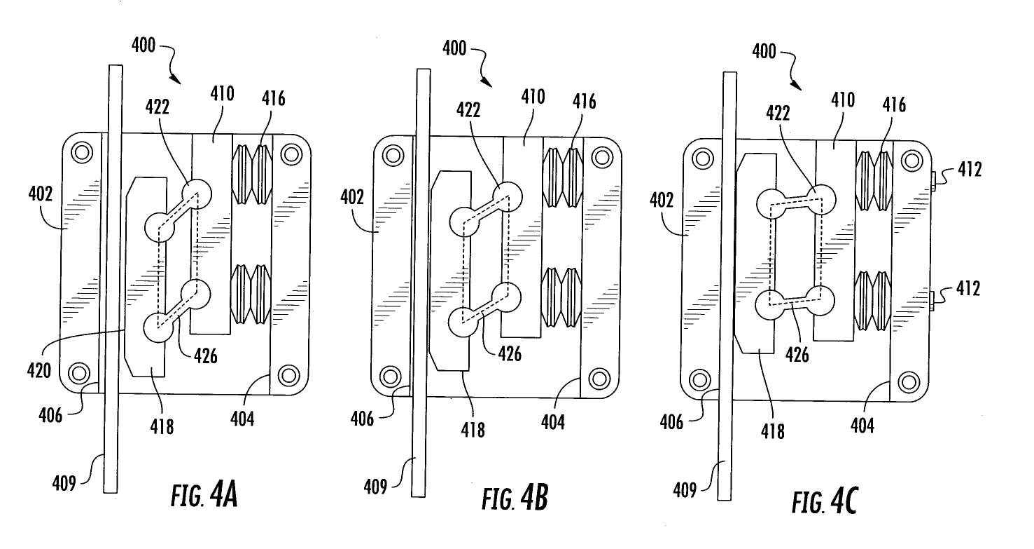

An engaging body 318 is moveably attached to the intermediate body 310. The engaging body 318 may define a second engaging surface 320. The engaging body 318 is rotatably attached or connected to the intermediate body 310 such that the engaging body 318 may move relative to the intermediate body 310. One or more pivots 322 may movably or rotatably connect or attach the engaging body 318 to the intermediate body 310. In some embodiments, the pivots 322 may be configured as rigid arms. In some embodiments, such as shown in FIGS. 4A-4C, the intermediate body 310, the engaging body 318, and the pivots 322 define a deformable parallelogram.

In operation, a guide rail may be positioned between the first engaging surface 306 and the second engaging surface 320. In normal operation of an elevator car, the first engaging surface 306 and the second engaging surface 320 do not engage the guide rail. However, in an emergency operation, the engaging body 318 may move toward the first engaging surface 306 in a rotating movement. The second engaging surface 320 of the engaging body 318 may engage with a surface of the guide rail. Further, as the engaging body 318 moves such that the second engaging surface 320 engages with the guide rail, a distance between the engaging body 318 and the first engaging surface 306 decreases. Accordingly, the first engaging surface 306 may also engage with the guide rail, on a surface that is opposite the surface of the guide rail that engages with the second engaging surface 320. When the first engaging surface 306 and the second engaging surface 320 engage with the guide rail, the elevator safety block 300 may provide a braking force to stop an elevator structure in the event of an emergency. As will be appreciated by those of skill in the art, the first engaging surface 306 and the second engaging surface 320 may each be configured and formed from materials and/or surface textures that are configured to provide braking or stopping force to an elevator car or counterweight. In some embodiments, the engaging body 318 may be configured as a brake pad or similar structure.

After the elevator safety block 300 is used to stop an elevator car or counterweight, the elevator safety block 300 may need to be released to enable movement or normal operation of the elevator car. The engaging surfaces (306, 320) of the elevator safety block 300 may frictionally engage with the guide rail, and thus the frictional force must be overcome to disengage the elevator safety block 300 and allow movement of the elevator car or counterweight. In accordance with embodiments disclosed herein, and for example with the elevator safety block 300 of FIGS. 3A-3C, the pivot engagement between the engaging body 318 and the intermediate body 310, along with the translational or sliding movement of the intermediate body 310 relative to the support surface 304, enables easy release or disengagement of the elevator safety block 300 from a guide rail.

Turning now to FIGS. 4A-4C, the operation of an elevator safety block 400 in accordance with an embodiment of the present disclosure is shown. In FIGS. 4A-4C, the elevator safety block 400 is substantially similar to the elevator safety block 300 of FIGS. 3A-3C, and thus similar features will have similar reference numerals, except preceded by a “4” rather than a “3.” Various features may not be described again for simplicity. FIGS. 4A-4C, when viewed in order, provide an example of a braking operation during an emergency situation of an elevator car. When viewed in reverse order, FIGS. 4A-4C provide an example of a release operation of the elevator safety block 400.

FIG. 4A shows a side view of an elevator safety block 400 as configured relative to a guide rail 409 in a first position. In the first position, an engaging body 418 does not engage with the guide rail 409, and thus the movement of an elevator car along the guide rail 409 is not impeded. Also shown in FIG. 4A is a representation of the deformable parallelogram 426 (dashed lines) defined by the intermediate body 410, the engaging body 418, and the pivots 422, as configured in the first position.

When an emergency event occurs, such as a high speed descent of an elevator car or counterweight, the elevator safety block 400 may be activated or actuated to stop the elevator car or counterweight. As shown in FIG. 4B, an intermediate or transitional position is shown. In FIG. 4B, the engaging body is shown moved toward the first engaging surface 406 of the frame 402. As shown, the parallelogram 426 is deformed into a different configuration. Relative to the orientation of FIG. 4B, the engaging body 418 has moved up and to the left, as compared to the position of the engaging body 418 in the first position (FIG. 4A). In

FIG. 4B, the second engaging surface 420 of the engaging body 418 may or may not be in contact with the guide rail 409. Further, the first engaging surface 406 of the frame 402 may or may not be in contact with the guide rail 409.

As shown in FIG. 4C, with the elevator safety block 400 shown in the second position, the guide rail 409 is engaged on opposing sides by components of the elevator safety block 400 to provide a braking or locking action. That is, the first engaging surface 406 and the second engaging surface 420 are engaged with respective surfaces of the guide rail 409 to provide frictional and compressive engagement with the guide rail 409 to stop an elevator car or counterweight from moving.

As shown in FIG. 4C, the parallelogram 426 has changed or deformed further. In this position, the distance between the engaging body 418 and the intermediate body 410 is the greatest. As will be appreciated by the movement depicted from FIG. 4A to FIG. 4C, the engaging block 418 moves upward and to the left. However, the engaging block 418 can only move so far before contacting the guide rail 409. When the engaging block 418 contacts the guide rail 409, and because the frame 402 may be rigidly connected to an elevator car or counterweight, the intermediate body 410 must move. Because the pins 412 of the intermediate body 410 are slidably retained within the support apertures (e.g., support apertures 314), the intermediate body 410 may move relative to the frame 402.

As shown in FIG. 4C, the elevator safety block 400 is in the second position, wherein the guide rail 409 is engaged between the first engaging surface 406 and the second engaging surface 420. Further, as shown, a portion of the pins 412 of the intermediate body 410 may extend out of the frame 402 through the support apertures. Additionally, in this position, the biasing devices 416 may be compressed between the intermediate body 410 and the support surface 404 of the frame 402.

During the process changing from FIG. 4A to FIG. 4C, i.e., moving from the first position (FIG. 4A) to the second position (FIG. 4C), the elevator safety block 400 moves downward relative to a point on the guide rail 409 and the engaging body 418 moves upward relative to the frame 402 of the elevator safety block 400. At the same time, the intermediate body 410 moves laterally or translates toward the support surface 404 and compresses the biasing devices 416. As shown in FIGS. 4A-4C, the engaging body 418 is configured to remain parallel to the guide rail 409 at all times, allowing for optimal space configuration and preventing interference with the guide rail during normal operation, yet providing maximum braking power or force during an emergency situation. Because of this, the parallelogram 426 is defined.

After the elevator safety block 400 is engaged into the second position (FIG. 4C) and stops or halts the movement of an elevator car or counterweight, it may be desired to disengage the elevator safety block 400 to re-enable movement of the elevator car. In contrast to a traditional wedge or roller locking/braking system, embodiments disclosed herein enable an easy release or disengagement mechanism.

By simply moving the elevator car or counterweight upward using normal power, the engaging body 418 may disengage from the guide rail 409 and allow for full disengagement of the elevator safety block 400 from the guide rail 409. That is, the opposite movement shown in FIGS. 4A-4C is performed, such that the order of movement is FIG. 4C, then FIG. 4B, then FIG. 4A, with the elevator safety block attaining the first position (FIG. 4A) after the disengagement operation.

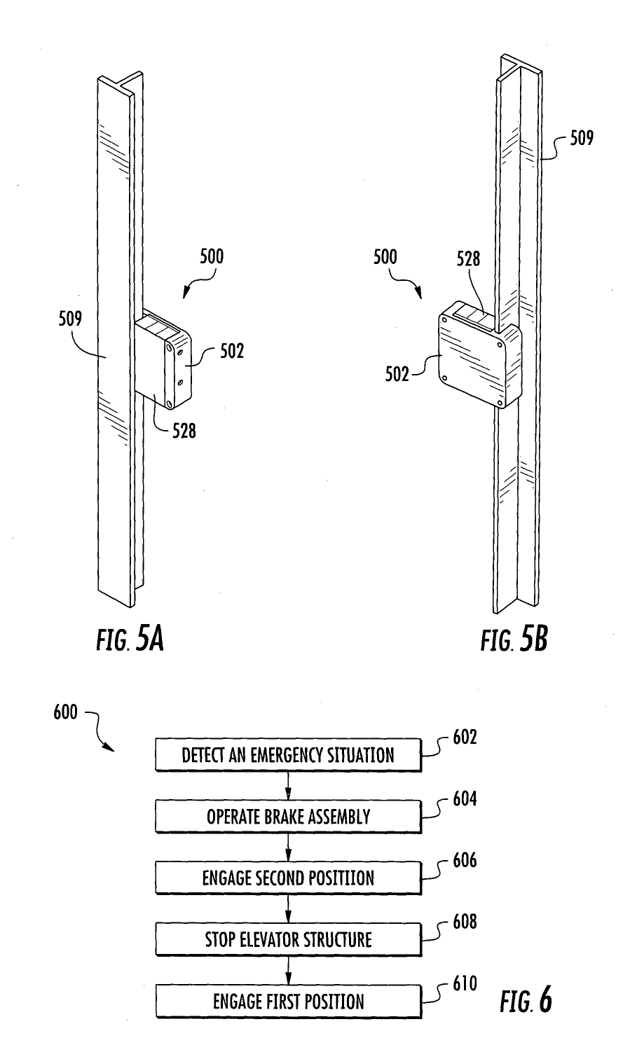

Turning now to FIGS. 5A-5B, various schematic views of an elevator safety block 500 in accordance with an example embodiment are shown. FIGS. 5A-5C show the elevator safety block 500 as mounted on a guide rail 509. The frame 502 is shown housing the components of the elevator safety block 500. Further, as shown, in some embodiments a cover 528 may be provided that is configured to protect the components of the elevator safety block 500.

Turning now to FIG. 6, the steps of a process for operating an elevator structure, such as an elevator car or counterweight, in an emergency situation is shown. At step 602, an emergency situation may be detected. Such detection may be by an elevator controller, mechanical device, or other type of device, mechanism, or system that is configured to determine or monitor for emergency situations. An emergency situation may be in instance where an elevator structure is traveling at an excessive speed, may be a situation where an elevator structure is in free-fall, may a situation where power is lost to the building and stopping the elevator structure may be for safety reasons, or for any other situation wherein it is desired to stop an elevator structure.

When an emergency situation is detected, an elevator safety block may be operated to stop the elevator structure at step 604. The operation may be by actuation, whether mechanical, electrical, or a combination thereof. The elevator safety block may be configured similarly to the assemblies and embodiments shown and described above.

During operation of the elevator safety block at step 604, the elevator safety block may be actuated or engaged, at step 606, into a second position from a first position. For example, the first position may be the position or configuration as shown in FIG. 4A and the second position may be the position or configuration as shown in FIG. 4C. In the second position, the elevator safety block may be engaged to stop an elevator structure from moving. That is, one or more engaging surfaces of the elevator safety block may be engaged with a guide rail to frictionally stop an elevator structure, such as an elevator car or counterweight, from moving downward, at step 608.

After the elevator structure is stopped at step 608, it may be desired to release the elevator structure to enable movement of the elevator structure. That is, the elevator structure may be moved such that the elevator safety block is moved from the second position to the first position, such that the first position (e.g., FIG. 4A) is engaged at step 610. Engaging the first position may involve operating the elevator structure such that it is moved upward by normal operational control, which may release the elevator safety block from the second position engagement. Accordingly, the first position will be engaged and the elevator car may be free to move within an elevator shaft.

Advantageously, embodiments described herein provide an elevator safety block for an elevator system that allows for effective emergency braking. Further, advantageously, after a braking operation, embodiments disclosed herein provide for an easy release or disengagement of the elevator safety block. Moreover, embodiments described herein allow for the elimination of the use of a rail grabber to release or disengage an elevator safety block from engagement with a guide rail. Furthermore, operation of an elevator structure, such as an elevator car or counterweight, may be performed at normal or less than normal operating powers to release the elevator safety block that is configured in accordance with embodiments disclosed herein. Advantageously, in accordance with some embodiments, the addition of the biasing devices provides a progressive safety system for emergency stopping of an elevator structure.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

For example, although shown with spring washers as the biasing devices, those of skill in the art will appreciate that other types of biasing devices may be used without departing from the scope of the disclosure. For example, leaf springs may be used to bias the intermediate body. Further, although shown with two pins, the intermediate body may be configured to any number of pins or other structures that enable the intermediate body to translate or slide relative to the frame. Moreover, although shown and described with four pivots, those of skill in the art will appreciate that any number of pivots may be provided that moveably connect the intermediate body and the engaging body, e.g., two or more pivots.

Further, although shown and described with respect to the elevator safety block attached to an elevator car, those of skill in the art will appreciate that embodiments described herein may be attached to other components or structures within an elevator shaft. For example, elevator safety blocks, as described herein, may be installed on or attached to counterweights that are used within elevator systems.

Accordingly, the present disclosure is not to be seen as limited by the foregoing description, but is only limited by the scope of the appended claims.

1. An elevator safety block comprising:
a frame configured to attach to an elevator structure and slidably engage with a guide rail, the frame defining a first engaging surface and a support surface;
an intermediate body slidably mounted to the support surface; and
an engaging body rotatably attached to the intermediate body and having a second engaging surface,
wherein, in a first position, the first engaging surface and the second engaging surface are configured to permit the elevator structure to move along the guide rail, and, in a second position, the first engaging surface and the second engaging surface are configured to engage with the guide rail and prevent movement of the elevator structure, and
wherein the elevator structure is one of an elevator car and a counterweight.

2. The elevator safety block of claim 1, wherein the frame includes at least one support aperture passing through the support surface, the intermediate body comprising at least one pin configured to slidably move within the at least one support aperture.

3. The elevator safety block of claim 2, further comprising at least one biasing device located on the at least one pin and positioned between the intermediate body and the support surface.

4. The elevator safety block of claim 1, further comprising at least one pivot configured to rotatably attach the engaging body to the intermediate body.

5. The elevator safety block of claim 4, wherein the at least one pivot is two pivots, and wherein the engaging body, the intermediate body, and the two pivots define a deformable parallelogram.

6. The elevator safety block of claim 1, wherein the engaging body is configured to move to the second position when the elevator structure is in an emergency situation.

7. The elevator safety block of claim 1, wherein the engaging body is positioned parallel to the guide rail in both the first position and the second position.

8. The elevator safety block of claim 1, further comprising a cover configured to protect the intermediate body and the engaging body within the frame.

9. A method of operating an elevator safety block comprising:
detecting an emergency situation of an elevator structure;
operating an emergency elevator safety block on the elevator structure to move from a first position to a second position; and
engaging the second position such that a guide rail is engaged between a first engaging surface of a frame of the emergency elevator safety block and a second engaging surface of an engaging body of the emergency elevator safety block to thereby prevent the elevator structure from moving relative to the guide rail,
wherein, in the first position, the emergency elevator safety block is configured to permit the elevator car to move freely with respect to the guide rail, and
wherein the elevator structure is one of an elevator car and a counterweight.

10. The method of claim 9, wherein the elevator safety block comprises a first engaging surface on a frame and a second engaging surface on an engaging body, the method further comprising maintaining the first engaging surface and the second engaging surface in parallel relationship in both the first position and the second position.

11. The method of claim 10, wherein engaging the second position comprises rotatably moving the engaging body with respect to the frame.

12. The method of claim 10, wherein the elevator safety block further comprises an intermediate body configured between the engaging body and a support surface of the frame.

13. The method of claim 12, wherein engaging the second position comprises translating the intermediate body with respect to the frame.

14. The method of claim 9, further comprising disengaging the elevator safety block from the second position to enable movement of the elevator structure.

15. The method of claim 14, wherein the disengaging comprises moving the elevator structure upward within an elevator shaft.
